(19) United States
(12) Patent Application Publication
(10) Pub. No.: US 2016/0017724 A1
(43) Pub. Date: Jan. 21, 2016

(54) VARIABLE THICKNESS TRAILING EDGE CAVITY AND METHOD OF MAKING

(71) Applicant: UNITED TECHNOLOGIES CORPORATION, Hartford, CT (US)

(72) Inventor: JinQuan Xu, East Greenwich, RI (US)

(73) Assignee: United Technologies Corporation, Hartford, CT (US)

(21) Appl. No.: 14/781,732

(22) PCT Filed: Mar. 21, 2014
(86) PCT No.: PCT/US2014/031472

§ 371 Date: Oct. 1, 2015

Related U.S. Application Data
(60) Provisional application No. 61/807,891, filed on Apr. 3, 2013.

(51) Int. Cl. F01D 5/28; B22D 25/02; B22C 9/10; B22F 3/105; F01D 5/18; F01D 9/04

(52) U.S. Cl. CPC F01D 5/282; F01D 5/18; F01D 9/041; B22C 9/101; B22F 3/1055; B22D 25/02; F05D 2220/32; F05D 2230/13; F05D 2230/14; F05D 2230/21; F05D 2230/60; F05D 2260/202; F05D 2300/13; F05D 2300/20; B33Y 10/00

(57) ABSTRACT

A method for forming an airfoil includes forming a ceramic core, forming a refractory metal core using additive manufacturing, joining the ceramic core and the refractory metal core to form a hybrid core, and casting the airfoil around the hybrid core. The ceramic core is used to define an internal cavity of the airfoil. The refractory metal core has an upstream end and a downstream end. The upstream end has a lateral thickness greater than a lateral thickness of the downstream end. The refractory metal core is used to define a trailing edge cavity within the airfoil. The trailing edge cavity is in flow communication with the internal cavity of the airfoil and trailing edge slots located on an outer surface of the airfoil near a trailing edge. This method provides for an airfoil having a trailing edge cavity of variably thickness and casting cores used for their manufacture.

### BACKGROUND

The airfoil portions of some blades and vanes used within gas turbine engines are subjected to extremely high temperatures. Internally cooled airfoils (of both blades and vanes) are generally capable of operating at higher temperatures than solid metal airfoils. Internally cooled airfoils contain cavities and passages through which a cooling fluid flows. Cooling fluid flowing through the cavities and passages absorbs thermal energy from the walls of the airfoil. In the case of impingement cooling, cooling fluid is directed at the internal walls of the airfoil so that heat is transferred from the airfoil wall to the cooling fluid. In some configurations, this cooling fluid then exits the airfoil through cooling holes located on the external surface of the blade or vane to form a thin film of cooling air. This cooling film insulates the outer surface of the airfoil from high temperature gases flowing past the airfoil.

Some state of the art airfoils include a central cavity through which cooling fluid flows. A thin trailing edge cavity extends from the central cavity to the trailing edge of the airfoil. Cooling fluid flows through the central cavity and the trailing edge cavity before it exits through trailing edge slots along the pressure or suction side wall of the airfoil near the airfoil trailing edge. In these state of the art airfoils, the trailing edge cavity is generally very thin and has a generally uniform thickness from its upstream end to its downstream end and from its root to its tip. These thin, uniform cavities provide limited options for modifying the flow of cooling fluid and optimizing cooling efficiency.

### SUMMARY

A method for forming an airfoil includes forming a ceramic core, forming a refractory metal core using additive manufacturing, joining the ceramic core and the refractory metal core to form a hybrid core, and casting the airfoil around the hybrid core. The ceramic core is used to define an internal cavity of the airfoil. The refractory metal core has an upstream end and a downstream end. The upstream end has a lateral thickness greater than a lateral thickness of the downstream end. The refractory metal core is used to define a trailing edge cavity within the airfoil. The trailing edge cavity is in flow communication with the internal cavity of the airfoil and trailing edge slots located on an outer surface of the airfoil near a trailing edge.

A hybrid core includes a ceramic core for forming an internal cavity within an airfoil and a refractory metal core for forming a plurality of trailing edge slots within the airfoil. The refractory metal core includes an upstream end extending from an inner radial end to an outer radial end and a downstream end generally opposite the upstream end and extending from an inner radial end to an outer radial end. The upstream end has a first thickness at a given radial location and the downstream end has a second thickness at the given radial location where the first thickness is generally greater than the second thickness at the given radial location.

An airfoil includes a leading edge, a trailing edge, a pressure side wall extending from the leading edge to the trailing edge, a suction side wall extending from the leading edge to the trailing edge generally opposite the pressure side wall, an internal cavity located between the pressure side wall and the suction side wall, and a trailing edge cavity extending downstream from the internal cavity between the pressure side wall and the suction side wall. The trailing edge cavity includes an upstream end and a downstream end where a first distance measured between the pressure side wall and the suction side wall at the upstream end is greater than a second distance measured between the pressure side wall and the suction side wall at the downstream end.

A method for forming a hybrid core used to cast an airfoil includes forming a ceramic core that is used to define an internal cavity of the airfoil, forming a refractory metal core that is used to define a trailing edge cavity within the airfoil using additive manufacturing, and joining the ceramic core and the refractory metal core to form a hybrid core. The refractory metal core has an upstream end and a downstream end where the upstream end has a lateral thickness greater than a lateral thickness of the downstream end.

### BRIEF DESCRIPTION OF THE DRAWINGS

FIG. 1 is a perspective view of one embodiment of an airfoil having a trailing edge slot according to the present invention.

FIG. 2A is a cross section view of the airfoil of FIG. 1 along the line A-A.

FIG. 2B is a cross section view of the airfoil of FIG. 1 along the line B-B.

FIG. 2C is a cross section view of the airfoil of FIG. 1 along the line C-C.

FIG. 3A is a side view of a hybrid core used to form the airfoil of FIG. 1.

FIG. 3B is a perspective view of the hybrid core of FIG. 3A.

### DETAILED DESCRIPTION

Airfoils according to embodiments of the present invention possess trailing edge cavities having variable thicknesses. The trailing edge cavities are not limited to the thin passages found in prior art airfoils. Variable thickness trailing edge cavities can be tailored to have a desired flow convergence or pressure drop in the trailing portion of the airfoil. Variable thickness trailing edge cavities can also reduce the wall thickness of the airfoil in the trailing portion of the airfoil, better facilitating cooling of the trailing edge region, and better provide accommodation for more advanced turbulators, pedestals and other cooling features. The features of the airfoil can be cast using a hybrid core having a ceramic core and a refractory metal core. Additive manufacturing can be used to create the refractory metal core. While descriptions herein refer to airfoils, variable thickness cores can be used to form variable thickness cavities in other gas turbine engine components, such as blade outer air seals, combustor liners and turbine exhaust case liners.

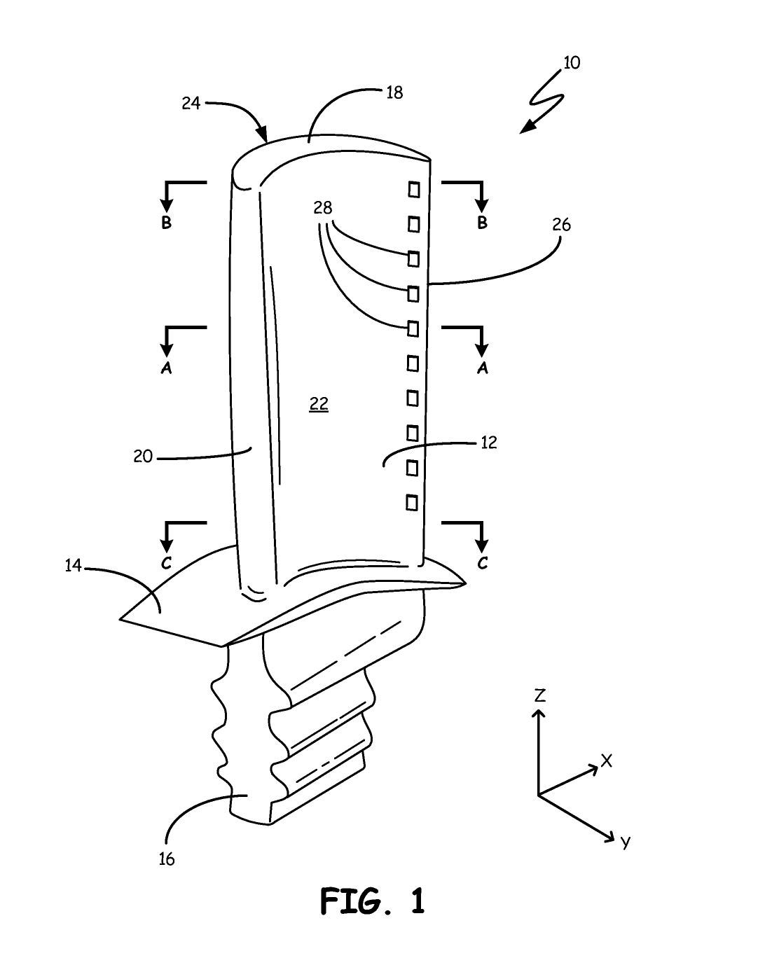

FIG. 1 illustrates a perspective view of one embodiment of an airfoil having a trailing edge cavity according to the present invention. FIG. 1 illustrates blade 10 having airfoil 12, platform 14, root 16 and tip 18. While FIG. 1 illustrates a blade, airfoil 12, as described herein, can also be applicable to vanes.

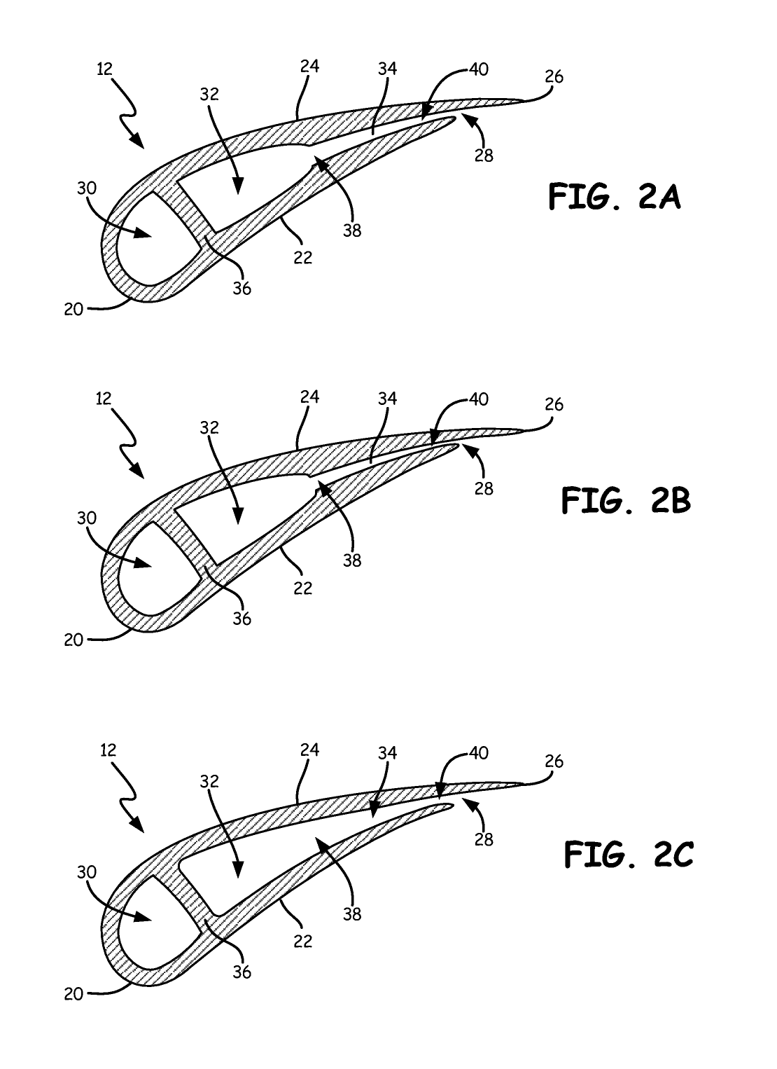

Airfoil 12 extends radially (z direction) from platform 14 to tip 18. Airfoil 12 includes leading edge 20, pressure side wall 22, suction side wall 24 and trailing edge 26. A plurality of trailing edge slots 28 are located along pressure side wall 22 near trailing edge 26. FIGS. 2A, 2B and 2C illustrate cross sections of airfoil 12 of FIG. 1 according to section lines A-A, B-B and C-C, respectively. FIG. 2B illustrates a cross section near tip 18, FIG. 2C illustrates a cross section near platform 14 and FIG. 2A illustrates a cross section at an intermediate region of airfoil 12. FIGS. 2A, 2B and 2C show cross section views through portions of airfoil 12 having trailing edge slots 28. As shown in FIG. 1, trailing edge slots 28 are separated from one another by the solid metal (or other) material that makes up pressure side wall 22.

FIG. 2A shows a cross section of airfoil 12 at a mid-span location (approximately half-way between platform 14 and tip 18) of blade 10. FIG. 2A illustrates the interior of airfoil 12 at this radial location and shows leading edge 20, pressure side wall 22, suction side wall 24, trailing edge 26, leading edge cavity 30, central cavity 32, trailing edge cavity 34 and slot 28. Cooling fluid flows through leading edge cavity 30 to cool the region of airfoil 12 near leading edge 20. Leading edge cavity 30 is separated from central cavity 32 by rib 36. Cooling fluid flows through central cavity 32 to cool the mid chord region of airfoil 12. Cooling fluid also flows from central cavity 32 through trailing edge cavity 34 to slot 28 where it exits airfoil 12 along pressure side wall 22. Cooling fluid flowing through trailing edge cavity 34 and slot 28 cool the region of airfoil 12 near trailing edge 26. While not shown in FIG. 2A, it is understood that pressure side wall 22 and suction side wall 24 can also include other cooling features such as micro cooling circuits for additional cooling.

Trailing edge cavity 34 includes upstream end 38 located near central cavity 32 and downstream end 40 located near slot 28. As shown in FIG. 2A, upstream end 38 of trailing edge cavity 34 is wider than downstream end 40. That is, the distance measured between pressure side wall 22 and suction side wall 24 at upstream end 38 is greater than the distance measured between pressure side wall 22 and suction side wall 24 at downstream end 40.

FIG. 2B shows a cross section of airfoil 12 at a radial location near tip 18. As in FIG. 2A, FIG. 2B illustrates the interior of airfoil 12 at this radial location. Trailing edge cavity 34 includes upstream end 38 located near central cavity 32 and downstream end 40 located near slot 28. As shown in FIG. 2B, upstream end 38 of trailing edge cavity 34 is wider than downstream end 40. Upstream end 38 near tip 18 is also not as wide as upstream end 38 at the mid-span location shown in FIG. 2A.

FIG. 2C shows a cross section of airfoil 12 at a radial location near platform 14. As in FIGS. 2A and 2B, FIG. 2C illustrates the interior of airfoil 12 at this radial location. Trailing edge cavity 34 includes upstream end 38 located near central cavity 32 and downstream end 40 located near slot 28. As shown in FIG. 2C, upstream end 38 of trailing edge cavity 34 is wider than downstream end 40. Upstream end 38 near platform 14 is also wider than upstream end 38 at the mid-span location shown in FIG. 2A and upstream end 38 near tip 18 shown in FIG. 2B. Thus, upstream end 38 of trailing edge cavity 34 is widest near platform 14 and gradually gets thinner from platform 14 to tip 18. The average width of trailing edge cavity 34 is greater near the innermost radial end of airfoil 12 (platform 14) than near the outermost radial end (tip 18). This particular configuration can be suitable for airfoils of both blades and vanes, depending on the desired flow profile within trailing edge cavity 34.

While FIGS. 2A, 2B and 2C illustrate an airfoil in which the average width of the trailing cavity is greater near platform 14 than near tip 18, in other embodiments the average width of the trailing cavity is greater near tip 18 than near platform 14. This particular configuration can be particularly suitable for vane airfoils, depending on the desired flow profile within the trailing edge cavity. FIGS. 1, 2A, 2B and 2C illustrate airfoil 12 having a generally uniform thickness in the y direction to better illustrate the variable thickness of trailing edge cavity 34. In some embodiments, airfoil 12 will vary in thickness (y direction) along radial axis z. In these embodiments, the thicknesses of pressure side wall 22 and suction side wall 24 can be generally constant where trailing edge cavity 34 tapers from upstream end 38 to downstream end 40 as shown in FIGS. 2A, 2B and 2C.

Blade 10 and airfoil 12 described above and illustrated in FIGS. 1, 2A, 2B and 2C can be formed by casting blade 10 around a core. Using conventional ceramic and refractory metal cores to form blade 10 and airfoil 12 is not practicable. A durable ceramic core for forming downstream end 40 of trailing edge cavity 34 and trailing edge cavity 34 near tip 18 cannot be manufactured. The thin regions of a ceramic core are fragile and easy to break during casting, preventing the use of ceramic cores for creating trailing edge cavity 34. A refractory metal core (RMC) can be shaped so that it produces central cavity 32 and trailing edge cavity 34, but state of the art methods for forming RMCs with this type of geometry require initially forming the RMC to be larger than the desired shape and removing material until the desired shape is achieved, an expensive, wasteful and time-consuming process. According to the present invention, a hybrid core is used to cast blade 10 and airfoil 12.

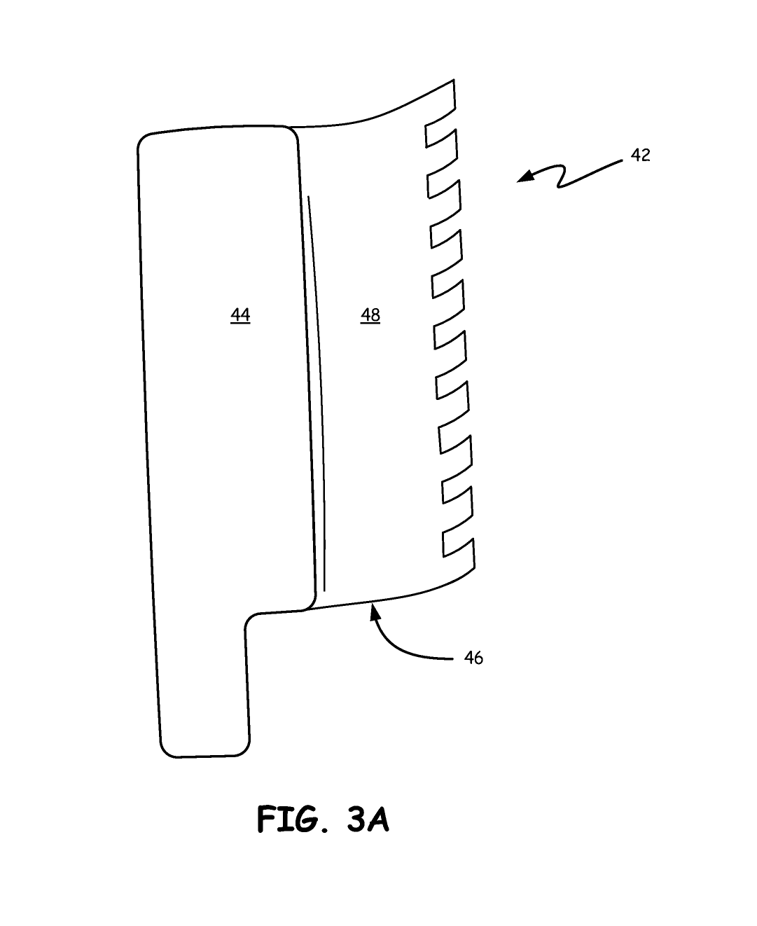

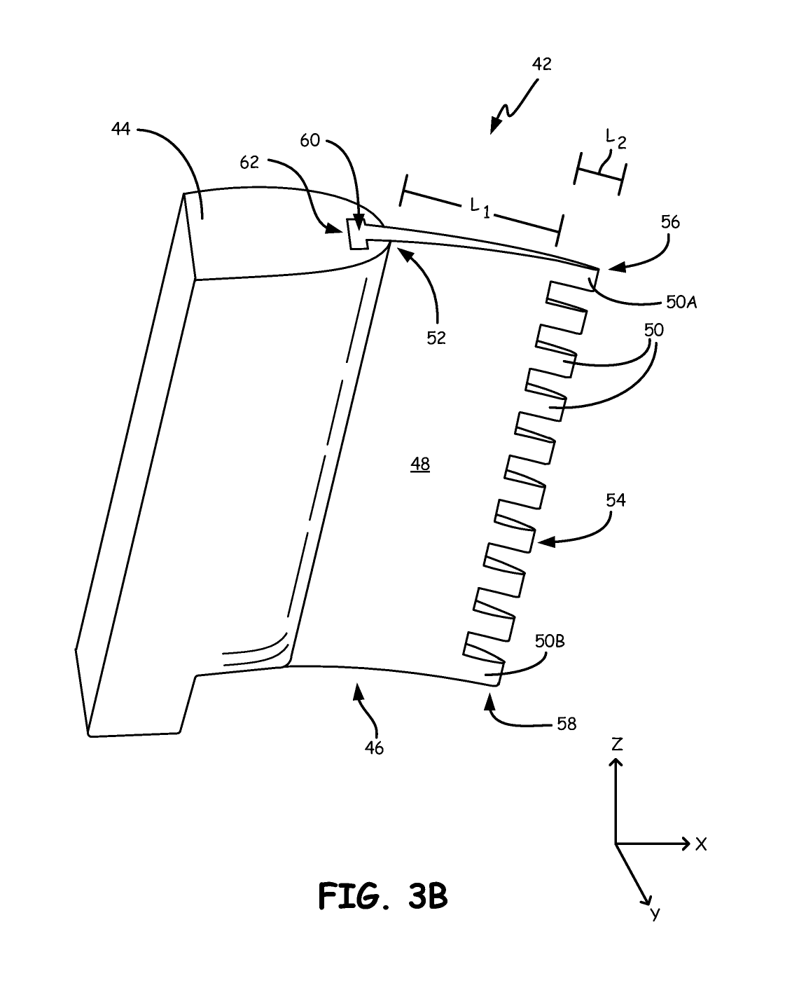

FIGS. 3A and 3B illustrate one embodiment of hybrid core 42 used to form blade 10 and airfoil 12. FIG. 3A shows a side view of hybrid core 42, and FIG. 3B shows a perspective view of hybrid core 42. Hybrid core 42 includes ceramic core 44 and RMC 46. Ceramic core 44 is shaped to form central cavity 22 of airfoil 12 during the casting process. Ceramic core 44 is formed of a ceramic material such as silica, zircon, aluminum silicate or alumina.

RMC 46 is shaped to form trailing edge cavity 34 and slots 28 of airfoil 12 during the casting process. RMC 46 is formed of a refractory metal. Suitable refractory metals include, but are not limited to, niobium, molybdenum, tantalum, tungsten, rhenium, titanium, vanadium, chromium, zirconium, hafnium, ruthenium, osmium and iridium. RMC 46 includes main body 48 and projections 50. Main body 48 extends from upstream end 52 of RMC 46 towards downstream end 54 of RMC 46. Projections extend from main body 48 to downstream end 54. Main body 48 forms trailing edge cavity 34 while projections 50 form slots 28 in airfoil 12.

The chordwise lengths of main body 48 (represented as L₁ in FIG. 3B) and projections 50 (L₂) can vary depending on the desired geometry of trailing edge cavity 34 and slot 28. For example, in some embodiments of airfoil 12, trailing edge cavity 34 extends from central cavity 22 nearly completely to slot 28. As a result, main body 48 typically has a large chordwise length L₁ while projections 50 have a relatively small chordwise length L₂ as shown in FIG. 3B. In other embodiments, cooling fluid channels are formed between trailing edge cavity 34 and slots 28. In these embodiments, projections 50 typically have a larger chordwise length L₂ while main body 48 has a relatively small chordwise length L₁. In some embodiments, the ends of projections 50 can also be connected downstream of where they form slot 28 in airfoil 12 to provide additional structural support to RMC 46. In some embodiments, RMC 46 can also include shapes and features for forming pedestals and turbulators within airfoil 12.

RMC 46 is generally thicker at upstream end 52 than it is at downstream end 54 as shown in FIG. 3B in order to form airfoil 12 described above and illustrated in FIGS. 2A, 2B and 2C. Thus, at a given radial location (along the z axis), upstream end 52 of RMC 46 has a greater thickness than downstream end 54 of RMC 46. In some embodiments, RMC 46 is generally thinner at one radial extreme and thicker at the other radial extreme. For example, as shown in FIG. 3B, the thickness (y direction) of RMC 46 near inner end 58 is generally greater than the thickness of RMC 46 near outer end 56 as can be observed by the relative thicknesses of projection 50A near outer end 56 and projection 50B near inner end 58. Projection 50B has a generally greater thickness than projection 50A. Refractory metal cores 46 that are thicker near inner end 58 than outer end 56 can be suitable for forming airfoils 12 for blades or vanes.

In other embodiments, the thickness of RMC 46 near outer end 56 is generally greater than the thickness of RMC 46 near inner end 58. Refractory metal cores 46 thicker near outer end 56 than inner end 58 can be suitable for forming airfoils 12 for vanes.

In some embodiments, a portion of RMC 46 has a thickness less than 1.52 mm (0.060 inches). In one particular embodiment, a portion of RMC 46 has a thickness less than 0.51 mm (0.020 inches). In some embodiments, a portion of ceramic core 44 has a thickness greater than 0.51 mm (0.020 inches). In one particular embodiment, a portion of ceramic core 44 has a thickness greater than 1.52 mm (0.060 inches).

In some embodiments, RMC 46 is joined to ceramic core 44. RMC 46 can be joined to ceramic core 44 using a ceramic glue or other adhesive suitable for joining RMC 46 and ceramic core 44 during casting. In some embodiments, RMC 46 and ceramic core 44 are joined using complimentary attachment structures. As shown in FIG. 3B, RMC 46 includes projection 60 upstream of main body 48. In some embodiments, such as the one shown in FIG. 3B, projection 60 includes a flange to better secure RMC 46 to ceramic core 44. Projection 60 can extend the radial length of RMC 46 or for only a portion of the radial length. Ceramic core 44 includes complimentary shaped recess 62 for receiving projection 60. Prior to casting, projection 60 of RMC 46 is inserted into recess 62 of ceramic core 44 to form hybrid core 42. Ceramic glue and/or other fasteners can be used to keep ceramic core 44 and RMC 46 joined together once hybrid core 42 has been assembled.

According to embodiments of the present invention, RMC 46 is formed using additive manufacturing techniques. Additive manufacturing techniques allow the formation of RMCs 46 of varying thicknesses without the waste and extra time and costs associated with removing material from a large initial refractory metal core. Suitable additive manufacturing techniques for forming RMC 46 include, but are not limited to, selective laser melting, direct metal laser sintering, selective laser sintering and electron beam machining (e.g., electron beam melting and electron beam welding). The additive manufacturing technique chosen can depend on the type of refractory metal(s) used to form RMC 46. Each of these techniques involves heating a thin layer of a refractory metal and melting it so that it joins with another layer of the refractory metal. The heating/melting and joining process can be repeated several times until the final geometry of RMC 46 has been obtained.

More particularly, RMC 46 is formed by depositing a refractory metal layer on a starting substrate (formed of a refractory metal, such as a refractory metal sheet) and selectively heating the refractory metal layer so that it melts and joins with the starting substrate following solidification. This process is repeated until the desired geometry and thickness of RMC 46 has been formed. Depending on the type of refractory metal used to form RMC 46, different deposition methods can be used. The refractory metal can be a metal powder that is sprayed or placed on the starting substrate and subsequent layers of the refractory metal. Alternatively, thin layers of metal can be sequentially positioned along the starting substrate and subsequent layers of the refractory metal prior to each heating step. Refractory metals can also be formed into a slurry and brushed onto the starting substrate and subsequent layers of the refractory metal.

Once a layer of the refractory metal has been deposited on the starting substrate and subsequent layers of the refractory metal, the material is selectively heated above its melting temperature so that it fuses and joins with the growing substrate. The refractory metal layer is heated using a high powered laser or electron beam to deliver the energy necessary to melt the material. In some embodiments where an electron beam is used to heat the material, the entire part can be placed within a vacuum. After the melted refractory metal layer has solidified, an additional refractory metal layer is deposited and the heating process is carried out again. This series of steps (depositing, heating/melting, solidifying) is repeated until RMC 46 contains the desired three-dimensional shape and thickness.

Prior to formation, the desired geometric characteristics of RMC 46 are determined These characteristics generally include the shape, thicknesses, curvature and other three-dimensional qualities of RMC 46. Once these characteristics have been determined, a computer generates a computer-aided design (CAD) file, additive manufacturing file format (AMF) file or other type of file that provides instructions to control the additive manufacturing operation. This file contains information that controls the layer-by-layer depositing and melting process described above. In some embodiments, an additive manufacturing machine or system deposits the refractory metal layers and selectively melts them to form RMC 46.

Airfoil 12 can be cast using hybrid core 42 described above. In one embodiment of a method for forming airfoil 12, ceramic core 44 is formed. RMC 46 is formed using additive manufacturing so that it has an upstream end with a thickness generally greater than the thickness of its downstream end. Once ceramic core 44 and RMC 46 have been formed they are joined to form hybrid core 42. Airfoil 12 can be formed using investment casting techniques in conjunction with hybrid core 42 where ceramic core 44 forms internal cavity 32 and RMC 46 forms trailing edge cavity 38 and slots 28. This method is capable of providing an airfoil having a trailing edge cavity and trailing edge slots of varying thickness as described above.

### Discussion of Possible Embodiments

The following are non-exclusive descriptions of possible embodiments of the present invention.

A method for forming an airfoil can include forming a ceramic core, forming a refractory metal core using additive manufacturing, joining the ceramic core and the refractory metal core to form a hybrid core, and casting the airfoil around the hybrid core. The ceramic core is used to define an internal cavity of the airfoil. The refractory metal core has an upstream end and a downstream end. The upstream end has a lateral thickness greater than a lateral thickness of the downstream end. The refractory metal core is used to define a trailing edge cavity within the airfoil. The trailing edge cavity is in flow communication with the internal cavity of the airfoil and trailing edge slots located on an outer surface of the airfoil near a trailing edge

The method of the preceding paragraph can optionally include, additionally and/or alternatively, any one or more of the following features, configurations and/or additional components:

A further embodiment of the foregoing method can further include that the refractory metal core extends from an inner radial end to an outer radial end where the inner radial end has an average lateral thickness greater than an average lateral thickness of the outer radial end.

A further embodiment of any of the foregoing methods can further include that the refractory metal core extends from an inner radial end to an outer radial end where the outer radial end has an average lateral thickness greater than an average lateral thickness of the inner radial end.

A further embodiment of any of the foregoing methods can further include that the refractory metal core is formed using a technique selected from the group consisting of direct metal laser sintering, electron beam machining, selective laser sintering, laminated object manufacturing and combinations thereof.

A further embodiment of any of the foregoing methods can further include that the refractory metal core has an attachment structure that is received by the ceramic core during joining of the ceramic core and the refractory metal core.

A hybrid core can include a ceramic core for forming an internal cavity within an airfoil and a refractory metal core for forming a plurality of trailing edge slots within the airfoil. The refractory metal core can include an upstream end extending from an inner radial end to an outer radial end and a downstream end generally opposite the upstream end and extending from an inner radial end to an outer radial end. The upstream end can have a first thickness at a given radial location and the downstream end can have a second thickness at the given radial location where the first thickness is generally greater than the second thickness at the given radial location.

The hybrid core of the preceding paragraph can optionally include, additionally and/or alternatively, any one or more of the following features, configurations and/or additional components:

A further embodiment of the foregoing hybrid core can further include that the second thickness of the downstream end of the refractory metal core at an innermost radial location is greater than the second thickness of the downstream end of the refractory metal core at an outermost radial location.

A further embodiment of any of the foregoing hybrid cores can further include that the second thickness of the downstream end of the refractory metal core at an outermost radial location is greater than the second thickness of the downstream end of the refractory metal core at an innermost radial location.

A further embodiment of any of the foregoing hybrid cores can further include that the refractory metal core further has an attachment structure for connecting the refractory metal core to the ceramic core.

A further embodiment of any of the foregoing hybrid cores can further include that the attachment structure has a projection where the ceramic core includes an opening complimentary to the projection for receiving the attachment structure.

An airfoil can include a leading edge, a trailing edge, a pressure side wall extending from the leading edge to the trailing edge, a suction side wall extending from the leading edge to the trailing edge generally opposite the pressure side wall, an internal cavity located between the pressure side wall and the suction side wall, and a trailing edge cavity extending downstream from the internal cavity between the pressure side wall and the suction side wall. The trailing edge cavity can include an upstream end and a downstream end where a first distance measured between the pressure side wall and the suction side wall at the upstream end is greater than a second distance measured between the pressure side wall and the suction side wall at the downstream end.

The airfoil of the preceding paragraph can optionally include, additionally and/or alternatively, any one or more of the following features, configurations and/or additional components:

A further embodiment of the foregoing airfoil can further include that the trailing edge cavity extends from an inner radial location to an outer radial location where a third distance measured between the pressure side wall and the suction side wall at the upstream end at an innermost radial location is greater than a fourth distance measured between the pressure side wall and the suction side wall at the upstream end at an outermost radial location.

A further embodiment of any of the foregoing airfoils can further include that the trailing edge cavity extends from an inner radial location to an outer radial location where a third distance measured between the pressure side wall and the suction side wall at the upstream end at an innermost radial location is less than a fourth distance measured between the pressure side wall and the suction side wall at the upstream end at an outermost radial location.

A further embodiment of any of the foregoing airfoils can further include that the airfoil is part of a a component selected from the group consisting of a blade and a vane.

A method for forming a hybrid core used to cast an airfoil can include forming a refractory metal core that is used to define a trailing edge cavity within the airfoil using additive manufacturing and forming a ceramic core that is used to define an internal cavity of the airfoil. The refractory metal core can have an upstream end and a downstream end where the upstream end has a lateral thickness greater than a lateral thickness of the downstream end.

The method of the preceding paragraph can optionally include, additionally and/or alternatively, any one or more of the following features, configurations and/or additional components:

A further embodiment of the foregoing method can further include joining the ceramic core and the refractory metal core.

A further embodiment of any of the foregoing methods can further include that the refractory metal core extends from an inner radial end to an outer radial end, and wherein the inner radial end has an average lateral thickness greater than an average lateral thickness of the outer radial end.

A further embodiment of any of the foregoing methods can further include that the refractory metal core extends from an inner radial end to an outer radial end, and wherein the outer radial end has an average lateral thickness greater than an average lateral thickness of the inner radial end.

A further embodiment of any of the foregoing methods can further include that the refractory metal core has an attachment structure that is received by the ceramic core during joining of the ceramic core and the refractory metal core.

Although the present invention has been described with reference to preferred embodiments, workers skilled in the art will recognize that changes may be made in form and detail without departing from the spirit and scope of the invention.

1. A method for forming an airfoil, the method comprising:
forming a ceramic core;
forming a refractory metal core using additive manufacturing, wherein the refractory metal core has an upstream end and a downstream end, and wherein the upstream end has a lateral thickness greater than a lateral thickness of the downstream end;
joining the ceramic core and the refractory metal core to form a hybrid core; and
casting the airfoil around the hybrid core, wherein the ceramic core is used to define an internal cavity of the airfoil, and wherein the refractory metal core is used to define a trailing edge cavity within the airfoil, the trailing edge cavity being in flow communication with the internal cavity of the airfoil and trailing edge slots located on an outer surface of the airfoil near a trailing edge.

2. The method of claim 1, wherein the refractory metal core extends from an inner radial end to an outer radial end, and wherein the inner radial end has an average lateral thickness greater than an average lateral thickness of the outer radial end.

3. The method of claim 1, wherein the refractory metal core extends from an inner radial end to an outer radial end, and wherein the outer radial end has an average lateral thickness greater than an average lateral thickness of the inner radial end.

4. The method of claim 1, wherein the refractory metal core is formed using a technique selected from the group consisting of direct metal laser sintering, electron beam machining, selective laser sintering, laminated object manufacturing and combinations thereof.

5. The method of claim 1, wherein the refractory metal core comprises an attachment structure that is received by the ceramic core during joining of the ceramic core and the refractory metal core.

6. A hybrid core comprising:
a ceramic core for forming an internal cavity within an airfoil;
a refractory metal core for forming a trailing edge slot within the airfoil, the refractory metal core comprising:
an upstream end extending from an inner radial end to an outer radial end;
a downstream end generally opposite the upstream end and extending from an inner radial end to an outer radial end, wherein the upstream end has a first thickness at a given radial location and the downstream end has a second thickness at the given radial location and wherein the first thickness is generally greater than the second thickness at the given radial location.

7. The hybrid core of claim 6, wherein the second thickness of the downstream end of the refractory metal core at an innermost radial location is greater than the second thickness of the downstream end of the refractory metal core at an outermost radial location.

8. The hybrid core of claim 6, wherein the second thickness of the downstream end of the refractory metal core at an outermost radial location is greater than the second thickness of the downstream end of the refractory metal core at an innermost radial location.

9. The hybrid core of claim 6, wherein the refractory metal core further comprises an attachment structure for connecting the refractory metal core to the ceramic core.

10. The hybrid core of claim 9, wherein the attachment structure comprises a projection, and wherein the ceramic core comprises an opening complimentary to the projection for receiving the attachment structure.

11. An airfoil comprising:
a leading edge;
a trailing edge;
a pressure side wall extending from the leading edge to the trailing edge;
a suction side wall extending from the leading edge to the trailing edge generally opposite the pressure side wall;
an internal cavity located between the pressure side wall and the suction side wall;
a trailing edge cavity extending downstream from the internal cavity between the pressure side wall and the suction side wall, the trailing edge cavity comprising:
an upstream end; and
a downstream end, wherein a first distance measured between the pressure side wall and the suction side wall at the upstream end is greater than a second distance measured between the pressure side wall and the suction side wall at the downstream end.

12. The airfoil of claim 11, wherein the trailing edge cavity extends from an inner radial location to an outer radial location, and wherein a third distance measured between the pressure side wall and the suction side wall at the upstream end at an innermost radial location is greater than a fourth distance measured between the pressure side wall and the suction side wall at the upstream end at an outermost radial location.

13. The airfoil of claim 11, wherein the trailing edge cavity extends from an inner radial location to an outer radial location, and wherein a third distance measured between the pressure side wall and the suction side wall at the upstream end at an innermost radial location is less than a fourth distance measured between the pressure side wall and the suction side wall at the upstream end at an outermost radial location.

14. The airfoil of claim 12, wherein the airfoil is part of a component selected from the group consisting of a blade and a vane.

15. The airfoil of claim 13, wherein the airfoil is part of a component selected from the group consisting of a blade and a vane.

16. A method for forming a hybrid core used to cast an airfoil, the method comprising:
forming a refractory metal core that is used to define a trailing edge cavity within the airfoil using additive manufacturing, wherein the refractory metal core has an upstream end and a downstream end, and wherein the upstream end has a lateral thickness greater than a lateral thickness of the downstream end; and
forming a ceramic core that is used to define an internal cavity of the airfoil.

17. The method of claim 16, further comprising:
joining the ceramic core and the refractory metal core.

18. The method of claim 16, wherein the refractory metal core extends from an inner radial end to an outer radial end, and wherein the inner radial end has an average lateral thickness greater than an average lateral thickness of the outer radial end.

19. The method of claim 16, wherein the refractory metal core extends from an inner radial end to an outer radial end, and wherein the outer radial end has an average lateral thickness greater than an average lateral thickness of the inner radial end.

20. The method of claim 17, wherein the refractory metal core comprises an attachment structure that is received by the ceramic core during joining of the ceramic core and the refractory metal core.
